(19) United States
(12) Patent Application Publication
(10) Pub. No.: US 2023/0135051 A1
(43) Pub. Date: May 4, 2023

(54) PEDESTRIAN ROAD DATA CONSTRUCTION METHOD USING MOBILE DEVICE, AND SYSTEM THEREFOR

(71) Applicant: Si Wan Lee, Seoul (KR)

(72) Inventor: Si Wan Lee, Seoul (KR)

(21) Appl. No.: 17/776,549

(22) PCT Filed: Oct. 27, 2020
(86) PCT No.: PCT/KR2020/014734

§ 371 Date: Nov. 21, 2022

(30) Foreign Application Priority Data
Nov. 14, 2019 (KR) 10-2019-0145814
Oct. 26, 2020 (KR) 10-2020-0138974

(51) Int. Cl. G06F 16/29; G06Q 30/0207; G01C 21/00; G06V 20/10; G06T 7/246

(52) U.S. Cl. CPC G06F 16/29; G06Q 30/0236; G01C 21/3826; G01C 21/3815; G06V 20/176; G06T 7/246

(57) ABSTRACT

The present invention relates to a method for constructing pedestrian map data by using pedestrian road data acquired via a mobile device possessed by a pedestrian moving on a pedestrian road and providing, as a compensation, a reward according to the acquired pedestrian road data, and a system therefor, the method comprising the steps of: acquiring pedestrian road data for a pedestrian route of a pedestrian by using sensors provided within a mobile device possessed by the pedestrian; constructing, for each layer, pedestrian map data for the pedestrian route by using the pedestrian road data; and, when the acquisition of the pedestrian road data is completed, paying a differentiated reward according to location information of the pedestrian road data and the distance of the pedestrian route.

### TECHNICAL FIELD

The present invention relates to technology for constructing pedestrian road data, and more particularly, to a method and system for constructing pedestrian map data using pedestrian road data acquired through a mobile device of a pedestrian walking on a pedestrian road and providing a reward according to the acquired pedestrian road data as a compensation.

### RELATED ART

In the art, road information is captured as a video using a camera mounted to a vehicle, road data related to a road type and condition is acquired using the captured video, or road data related to the road type and condition is acquired through a closed-circuit television (CCTV).

To capture road information, not only an image of a road but also a location of the road is important. The location of the road is acquired through a current location of the vehicle using a global positioning system (GPS) and matched to the captured video of the road such that the location and the video of the road may be matched.

Here, in the art, it is limited to technology for acquiring road data of a road on which a vehicle moves. That is, in the art, it is limited to acquiring road data related to a type and a condition of a vehicle road and there is almost no technology for acquiring and generating data related to a pedestrian road type and feature for a pedestrian road on which a pedestrian walks.

Therefore, there is a need for technology for constructing more precise pedestrian map data by collecting and acquiring pedestrian road data on a pedestrian road on which a pedestrian moves.

### DETAILED DESCRIPTION

### Technical Subject

An object of the present invention is to acquire information on a road on which a pedestrian walks, that is, pedestrian road data through a sensor and a camera within a mobile device of a pedestrian that moves on a pedestrian road.

Also, an object of the present invention is to improve validity and accuracy by updating pedestrian map data related to a corresponding pedestrian road based on pedestrian road data that is acquired according to a movement of a pedestrian.

Also, an object of the present invention is to provide, as a compensation, a reward according to pedestrian road data collected through a mobile device of a pedestrian that moves on a pedestrian road.

Also, an object of the present invention is to realize advancement of a data lifecycle and advancement of a pedestrian road map based on an aggressive participation and experience of a user and to implement public benefit using pedestrian road data and artificial intelligence (AI) technology.

### Technical Solution

A pedestrian road data construction method according to an example embodiment includes acquiring pedestrian road data related to a pedestrian route of a pedestrian using sensors provided in a mobile device of the pedestrian; constructing pedestrian map data related to the pedestrian route for each layer using the pedestrian road data; and paying a reward differentiated according to location information of the pedestrian road data and a distance of the pedestrian route when acquisition of the pedestrian road data is completed.

The acquiring of the pedestrian road data may include acquiring travel route measurement data of a travel distance and a travel time according to the pedestrian route using a sensor in the mobile device and acquiring a pedestrian road image of the pedestrian route using a camera in the mobile device; and calculating walking speed data according to a movement of the pedestrian from the pedestrian road image and the travel route measurement data and processing the pedestrian road data than represents a pedestrian road type and feature.

Also, the pedestrian road data construction method according to an example embodiment may further include transmitting the pedestrian road data to a preset server when acquisition of the pedestrian road data is completed.

Also, the pedestrian road data construction method according to an example embodiment may further include inversely calculating a distance according to a movement of the pedestrian using the pedestrian road data.

A pedestrian road data construction system according to an example embodiment includes an acquirer configured to acquire pedestrian road data related to a pedestrian route of a pedestrian using sensors provided in a mobile device of the pedestrian; a manager configured to construct pedestrian map data related to the pedestrian route for each layer using the pedestrian road data; and a compensator configured to pay a reward differentiated according to location information of the pedestrian road data and a distance of the pedestrian route when acquisition of the pedestrian road data is completed.

The acquirer may include a data acquirer configured to acquire travel route measurement data of a travel distance and a travel time according to the pedestrian route using a sensor in the mobile device and to acquire a pedestrian road image of the pedestrian route using a camera in the mobile device; and a data processing configured to calculate walking speed data according to a movement of the pedestrian from the pedestrian road image and the travel route measurement data and to process the pedestrian road data that represents a pedestrian road type and feature.

Also, the pedestrian road data construction system according to an example embodiment may further include a transmitter configured to transmit the pedestrian road data to a preset server when acquisition of the pedestrian road data is completed.

Also, the pedestrian road data construction system according to an example embodiment may further include a calculator configured to inversely calculate a distance according to a movement of the pedestrian using the pedestrian road data.

### Effect

According to example embodiments, it is possible to acquire information on a road on which a pedestrian walks, that is, pedestrian road data through a sensor and a camera within a mobile device of a pedestrian that moves on a pedestrian road.

Also, according to example embodiments, it is possible to improve validity and accuracy by updating pedestrian map data related to a corresponding pedestrian road based on pedestrian road data that is acquired according to a movement of a pedestrian.

Also, according to example embodiments, it is possible to provide, as a compensation, a reward according to pedestrian road data collected through a mobile device of a pedestrian that moves on a pedestrian road.

Also, according to example embodiments, it is possible to realize advancement of a data lifecycle and advancement of a pedestrian road map based on an aggressive participation and experience of a user and to implement public benefit using pedestrian road data and artificial intelligence (AI) technology.

Also, according to example embodiments, it is possible to recommend pedestrian road data to be collectable from a pedestrian even in an area in which it is difficult to acquire pedestrian road data and, through this, to easily acquire pedestrian road data of various areas by differentiating a reward that is paid as a compensation according to an area in which pedestrian road data is acquired, for example, an area in which it is easy to acquire pedestrian road data and an area in which it is difficult to acquire pedestrian road data.

Also, according to example embodiments, it is possible to assist identification of an obstacle according to a situation by distinguishing an obstacle present on a road as a fixed obstacle or a non-fixed obstacle and by providing the same to pedestrian map data and to provide more efficient management and update of a map by constructing a pedestrian map for each layer.

According to the present invention, it is possible to verify pedestrian road information on a pedestrian road on which a pedestrian moves by visually displaying the pedestrian road on which the pedestrian moves on a pedestrian map of a corresponding area in a mobile device of the pedestrian and to improve accuracy of a pedestrian road travel route of the pedestrian by correcting pedestrian road data displayed on the pedestrian map according to a situation through a pedestrian input.

### BRIEF DESCRIPTION OF DRAWINGS

FIG. 1 is a flowchart illustrating a pedestrian road data construction method according to an example embodiment.

FIG. 2 illustrates an example of a process of acquiring pedestrian road data through a movement of a pedestrian according to an example embodiment.

FIG. 3 illustrates an example of pedestrian map data according to an example embodiment.

FIGS. 4A and 413 illustrate examples of a data collection through a cumulative route analysis according to an example embodiment.

FIGS. 5A to 5C illustrate examples of a data collection using a mobile device according to an example embodiment.

FIGS. 6A to 6F illustrate examples of an application user interface (LII) according to an example embodiment.

FIG. 7 is a block diagram illustrating a configuration of a pedestrian road data construction system according to an example embodiment.

### BEST MODE

Advantages and features of the present invention and methods to achieve the same will be apparent with reference to the accompanying drawings and the following example embodiments. However, the present invention is not limited to the example embodiments disclosed herein and may be implemented in various different forms. Here, the example embodiments are provided such that the disclosure of the present invention is complete and to completely inform the scope of the invention to those of ordinary skill in the art to which the present invention pertains and the present invention is defined by the scope of the claims.

The terms used herein is for describing example embodiments only, and is not construed to limit the present invention. Herein, the singular forms “a”, “an”, and “the” are intended to include the plural forms as well, unless the context clearly indicates otherwise. It will be further be stood that the terms “comprises” and/or “comprising” when used herein, specify the presence of stated features, integers, steps, operations, elements, and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which the present invention pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described in detail with reference to the accompanying drawings. Like reference numerals refer to like components throughout, wherever possible, even though they are shown in different drawings. Further description related thereto is omitted.

Example embodiments relate to constructing pedestrian map data for each layer with respect to a pedestrian route using pedestrian road data acquired through a mobile device of a pedestrian moving on a pedestrian road and providing a reward according thereto as a compensation.

Here, the present invention may acquire pedestrian road data representing a pedestrian road type such as a straight pedestrian road and a curved pedestrian road, presence or absence of stairs, presence or absence of hill, presence or absence of a lift, such as an elevator or an escalator, presence or absence of an obstacle, and presence or absence of a danger area using a sensor and a camera in a mobile device and to construct pedestrian map data for each layer by distinguishing a pedestrian obstacle as a fixed obstacle or a non-fixed obstacle based on the pedestrian road data, and to pay a reward to a user (or a pedestrian) that acquires the pedestrian road data as a compensation.

The present invention may refer to an application included in a mobile device of a user (or a pedestrian). The mobile device may be at least one terminal among a smartphone, a desktop personal computer (PC), a mobile terminal, a personal digital assistant (PDA), a laptop computer, a tablet PC, and a wearable device. Also, the mobile device may receive a selection and input of the user and may include a display in a form of a touchscreen that may perform an operation of a desired function set through a screen including a touch-sensing area and may be a device including at least one physical button or virtual button. Therefore, a type and a shape of the mobile device are not limited thereto.

Accordingly, a GPS sensor, an acceleration sensor, a gyro sensor, and a measurement device of a camera may be included in the mobile device and the present invention may acquire pedestrian road data using the mobile device.

A method and system for constructing pedestrian road data using a mobile device according to an example embodiment is based on social mapping that appropriately maps pedestrian road data collected from a plurality of users (or pedestrians) to pedestrian map data.

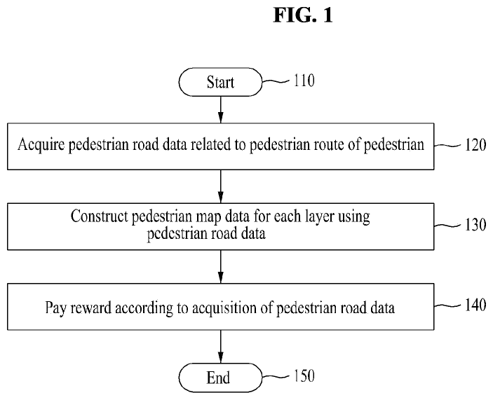

Hereinafter, the present inventions described in detail with reference to FIGS. 1 to 7.

FIG. 1 is a flowchart illustrating a pedestrian road data construction method according to an example embodiment.

Referring to FIG. 1, a pedestrian road data construction method according to an example embodiment constructs pedestrian map data using pedestrian road data that is acquired through a mobile device of a pedestrian moving on a pedestrian road and provides a reward according to the acquired pedestrian road data as a compensation.

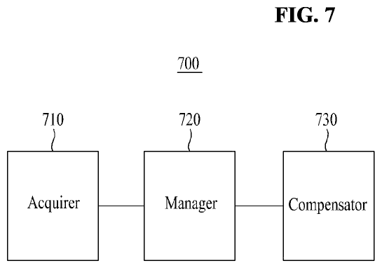

The method of FIG. 1 may be performed by a pedestrian road data construction system according to an example embodiment of FIG. 7.

Referring to FIG. 1, after start operation 110, pedestrian road data related to a pedestrian route of a pedestrian is acquired using sensors provided in a mobile device of the pedestrian in operation 120.

In detail, operation 120 may include a first operation (not shown) of acquiring travel route measurement data of a travel distance and a travel time according to the pedestrian route sing a sensor in the mobile device, for example, a GPS sensor, a magnetic sensor, an acceleration sensor, a gyro sensor, and a gravity sensor, and acquiring a pedestrian road image of the pedestrian route using a camera in the mobile device; and a second operation (not shown) of calculating walking speed data according to a movement of the pedestrian from the pedestrian road image and the travel route measurement data and processing the pedestrian road data that represents a pedestrian road type and feature.

Here, in operation 120, data related to a pedestrian road on which the pedestrian has moved may be acquired through the GPS sensor, the magnetic sensor, the acceleration sensor, the gyro sensor, and the gravity sensor provided in the mobile device, and a measurement device of the camera in such a manner that an application according to the method of the present invention installed on the mobile device is executed based on an input of the pedestrian.

The pedestrian road data acquired in the first operation may include location information, direction information, acceleration information, gyro information, and the like, and based on such information, travel route measurement data of a travel distance and a travel time according to a location of the pedestrian may be acquired by sensing a location of the pedestrian that moves on the pedestrian road in real time. For example, in the first operation, a location of the pedestrian that moves on the pedestrian road may be sensed using at least one sensor among the GPS sensor, the magnetic sensor, the acceleration senor, the gyro sensor, and the magnetic sensor in the mobile device, and the travel route measurement data representing the travel distance and the travel time according to the movement may be acquired through a change in a walking speed, direction, and altitude of the pedestrian. Here, the travel route measurement data may refer to data acquired from a sensor in the mobile device and may further include information related to a travel direction, a duration of time stayed at a single point, and a detour for avoiding an obstacle or a structure as well as the travel distance and the travel time according to the movement of the pedestrian.

In the first operation, a pedestrian road image captured from the pedestrian road in the pedestrian route may be acquired using the camera in the mobile device while the pedestrian is moving. For example, the pedestrian with the mobile device may take a photo of an interfering object in the pedestrian road, such as an obstacle present in the pedestrian road, icing, piled snow, or leaves, through the camera, while moving on the pedestrian road. In the first operation, the pedestrian road image of the obstacle may be acquired.

Further, in the first operation, travel route measurement data including inclination information, a camera direction, and a camera capturing location of the mobile device according to the movement of the pedestrian may be acquired. As an example embodiment, in the first operation, the travel route measurement data including presence or absence of a slope or hill on the road according to the inclination information, the camera direction, and the camera capturing location of the mobile device, an angle of inclination, and the pedestrian road image may be acquired using the gyro sensor and the camera included in the mobile device.

For example, the pedestrian may walk after putting the mobile device into a bag or clothes, may walk while holding the mobile device with the hand, may walk while viewing the mobile device, or may walk while taking a photo with the camera of the mobile device ON. Therefore, in the first operation, presence or absence of a slope or hill on the pedestrian road may be sensed and an angle of inclination of the slope or the hill may be verified by acquiring the travel distance and the travel time according to the movement of the pedestrian and by acquiring inclination information and a camera direction of the mobile device through at least one sensor among the GPS sensor, the magnetic sensor, the acceleration sensor, the gyro sensor, and the gravity sensor, and the camera. Also, in the first operation, when the pedestrian walks while taking a photo with the camera of the mobile device ON, the pedestrian road image may be acquired.

Therefore, in the first operation, more detailed information on the pedestrian road may be measured by acquiring travel route measurement data that includes a travel direction, a duration of time stayed at a single point, a detour for avoiding an obstacle or a structure, presence or absence of a slope or hill on the road, an angle of inclination, and a pedestrian road image as well as the travel distance and the travel time based on sensing data that is measured through a measurement device provided in the mobile device.

In the second operation, the pedestrian road type and feature may be acquired by calculating walking speed data according to the movement of the pedestrian from the travel route measurement data and by comparing the walking speed data to average speed data according to a movement between pre-stored separation distance points.

Further, in the second operation, when it is determined that the pedestrian has moved by way of a transportation method other than walking in acquiring pedestrian road data according to the travel route of the pedestrian, for example, when a travel speed of the pedestrian exceeds a desired reference speed, the pedestrian may be determined to have moved by way of the transportation method and corresponding pedestrian road data may be deleted from pedestrian road data of the pedestrian.

In detail, in the second operation, the pedestrian road data representing the pedestrian road type and feature may be acquired by calculating the walking speed data according to the movement of the pedestrian from the travel route measurement data. Here, in the second operation, the pedestrian road type and feature may be acquired by calculating an average speed, that is, the walking speed data according to the movement of the pedestrian from the travel route measurement data and by comparing the calculated walking speed data to the pre-stored average speed data according to the movement between the separation distance points. For example, in the second operation, when the pedestrian moves from point A to point B of a pedestrian road, walking speed data of an average speed according to a travel distance and a travel time may be calculated from the travel route measurement data acquired according to the movement of the pedestrian. In the second operation, at least one pedestrian road feature among a pedestrian road type, such as a straight pedestrian road and a curved pedestrian road, and presence or absence of stairs, presence or absence of hill, presence or absence of a lift, such as an elevator or an escalator, presence or absence of an obstacle, and presence or absence of a danger area may be acquired by comparing the walking speed data to the average speed data that is mechanically calculated from a distance from the point A to the point B, received from a database (not shown) or an external server. In the second operation, when a history related to a walking speed of the pedestrian is present, at least one pedestrian road feature among the pedestrian road type, such as the straight pedestrian road and the curved pedestrian road, and presence or absence of stairs, presence or absence of hill, presence or absence of a lift, such as an elevator or an escalator, presence or absence of an obstacle, and presence or absence of a danger area may be acquired through comparison between the walking speed of the pedestrian and the walking speed acquired from the travel route measurement data.

For example, in the second operation, when the walking speed data from the point A to the point B is faster than the average speed data with the assumption that the pedestrian road from the point A to the point B is the straight pedestrian road, it is determined that the obstacle or the danger area (e.g., a construction, etc.) present in the straight pedestrian road between the point A and the point B and hindering the movement of the pedestrian is resolved and a new pedestrian road feature, such as presence or absence of an obstacle in a corresponding area and presence or absence of a danger area, may be acquired.

As another example, in the second operation, when the walking speed data from the point A to the point B is slower than the average speed data, it is determined that one of stairs, hill, and a lift, such as an elevator or an escalator, is newly installed in the straight pedestrian road between the point A and the point B and a new pedestrian road feature, such as presence or absence of stairs, presence or absence of hill, presence or absence of a lift, such as an elevator or an escalator, in a corresponding area may be acquired.

Therefore, in the second operation, the pedestrian road type and feature may be verified by comparing the walking speed data to previous average speed data acquired for the corresponding pedestrian route and the pedestrian road data related to the corresponding pedestrian route through which only the pedestrian moves may be acquired.

When the pedestrian road data of the pedestrian route through which the pedestrian has moved or the travel route measurement data is acquired through operation 120, pedestrian map data related to the pedestrian route is constructed for each layer using the acquired pedestrian road data (operation 130).

In operation 130, the pedestrian map data constructed for each layer of a base map, a facility map, a pedestrian obstacle map, and a risk factor map may be generated using the pedestrian road data and an obstacle may be distinguished as a fixed obstacle or a non-fixed obstacle and generated into data in the pedestrian obstacle map. For example, in operation 130, the pedestrian map data may be constructed by generating the facility map, such as public facility, transportation facility, medical facility, educational facility, cultural tourism facility, convenience facility, and welfare center, on the base map that shows pedestrian road information and road information, by generating the pedestrian obstacle map of a fixed obstacle and a non-fixed obstacle on the facility map, and by generating the risk factor map, such as icing, construction, and an accident prone area, on a top layer.

Here, in operation 130, data related to a pedestrian obstacle may be updated through an analysis and verification process of processing and refining the pedestrian road data collected from the pedestrian and recognizing a location and a range of an obstacle and generating new obstacle data based on an artificial intelligence (AI) model learning. Also, in operation 130, a pedestrian road image of a risk factor, such as icing, collected from the pedestrian, may be classified through an AI model classification and obstacle data using a photo may be updated through an interface through classification data grouping and a geographic information system (GIS) data analysis.

Also, in operation 130, the pedestrian may visually verify the pedestrian route through which the pedestrian has moved in real time since the pedestrian road data is displayed on the pedestrian map data displayed on a screen of the mobile device.

Here, in operation 130, when displaying the pedestrian road data on a map, the pedestrian road data may be differently displayed according to a travel speed at which the pedestrian moves, a slope of a road, and the like. When the pedestrian route through which the pedestrian has moved is pre-stored, pedestrian map data related to an overlapping route may be updated using the pre-stored pedestrian road data of the corresponding route and newly measured pedestrian road data or may be updated with an average value.

Further, operation 130 may further include an operation of correcting the pedestrian road data that is displayed in real time on the screen or of which measurement is terminated and that is displayed on the screen based on an input of the pedestrian. For example, in operation 130, when the pedestrian road data displayed on the screen has a portion different from the pedestrian route of the pedestrian, the pedestrian road data may be corrected by correcting the pedestrian road data related to the different portion based on an input of the pedestrian. That is, the method according to the present invention may improve accuracy of the pedestrian road data acquired according to the pedestrian route of the pedestrian by determining an area to be corrected according to the input of the pedestrian in the pedestrian road data that is acquired based on sensing data measured by sensors and by correcting data of the area to be corrected based on input information of the pedestrian. The accuracy of the pedestrian road data may be improved through a signal processing process at a server and complexity of signal processing at the server may be reduced through the aforementioned correction operation of the pedestrian.

When the pedestrian road data is acquired through the above process and displayed on the pedestrian map data in real time and acquisition of the pedestrian road data is terminated in operation 130, a reward differentiated according to location information of the pedestrian road data and a distance of the pedestrian route is paid in operation 140 and the process is terminated through end operation 150.

In operation 140, when acquisition of the pedestrian road data is completed, information on a pedestrian road within a desired distance in which a reward is payable based on location information of the pedestrian and a reward payment method on the corresponding pedestrian road may be provided to the pedestrian. Here, in operation 140, a reward to be paid may be differentiated according to a location at which the pedestrian road data is acquired or the pedestrian route and, as an example embodiment, the differentiated reward may be provided by applying a weight differentiated by area to a reference reward.

For example, in operation 140, the reward to be paid to the pedestrian may be differentiated according to a case in which an acquisition location of the pedestrian road data is a pedestrian road in which a data acquisition is easy and a case in which the acquisition location is a pedestrian road in which a data acquisition is difficult, for example, a case in which it is a pedes road in which acquisition of the pedestrian road data is insufficient based on location information at which the pedestrian road data is acquired.

The pedestrian road data construction method according to an example embodiment may further include an operation of inversely calculating a distance according to the movement of the pedestrian into a time using the pedestrian road data. In detail, the operation of inversely calculating may calculate a time according to a movement between separation distance points of the pedestrian by inversely calculating the distance according to the movement of the pedestrian into the time into consideration of the travel route measurement data, based on the pedestrian road data that represents the pedestrian road type and feature.

For example, with the assumption that a pedestrian road from point C to point D is a curved pedestrian road including a right-turn course and an escalator is present right before arriving at the point D by turning right, the operation of inversely calculating may exclude a duration of time or a distance used to pass the escalator into consideration of a travel distance from travel route measurement data according to a movement of the pedestrian from the point C to the point D based on the aforementioned pedestrian road data of the pedestrian road type and feature, and may inversely calculate a travel time and an average time only with respect to a movement corresponding to a general pedestrian road, that is, a pedestrian road type (e.g., the curved pedestrian road including the right-turn course) in which the pedestrian road feature (e.g., the escalator) is excluded, Therefore, in the operation of inversely calculating, a pure travel time or average time according to the movement between separation distance points excluding the pedestrian road feature may be calculated.

When acquisition of the pedestrian road data is completed in operation 120, the pedestrian road data construction method according to an example embodiment may further include an operation of transmitting the pedestrian road data to a preset server. After acquisition of the pedestrian road data is completed, the pedestrian road data displayed on the pedestrian map data may be corrected based on an input of the pedestrian and the corrected pedestrian road data may be transmitted to the server. Depending on example embodiments, the present invention may transmit the pedestrian road data to the server and receive the pedestrian map data and the reward constructed by the server and may pay the pedestrian map data and the reward to the pedestrian using the mobile device through operations 130 and 140.

The server that receives the pedestrian road data through the operation of transmitting may acquire accurate information on each of pedestrian roads by collecting pedestrian road data from each of pedestrians and extracting data related to each of the pedestrian roads based on the collected pedestrian road data and then, analyzing the extracted data related to each of the pedestrian roads. For example, when pedestrian road data is received from pedestrian A, pedestrian B, and pedestrian C for the same pedestrian road, accurate pedestrian road data related to the corresponding pedestrian road may be acquired by averaging the pedestrian road data of the pedestrian A, the pedestrian road data of the pedestrian B, and the pedestrian road data of the pedestrian C and by comparing sidewalk data or pedestrian road data pre-stored for the corresponding pedestrian road to the averaged pedestrian road data. Here, for the corresponding pedestrian road, significantly different pedestrian road data may be excluded in analyzing the pedestrian road data. When pedestrian road data is updated for the corresponding pedestrian road, pedestrian road data stored for the corresponding pedestrian road may be updated with new data.

Also, the server may appropriately map pedestrian road data collected from a plurality of pedestrians to the pre-stored sidewalk data or pedestrian map data and may provide the same.

The server that receives the pedestrian road data from the pedestrians may improve validity and accuracy of the sidewalk data by analyzing the pedestrian road data and then combining the same with sidewalk data pre-stored for a corresponding area. For example, the server may improve validity and accuracy by comparing pedestrian road data acquired for a separation distance point between point A and point B to pre-stored sidewalk data and by updating the sidewalk data from the pedestrian road data. Here, the sidewalk data may refer to raw data related to a pedestrian road and may include a street type, a length, a width, and a feature for each pedestrian road designed during road construction. Also, the sidewalk data may refer to a base map that is a basic to the pedestrian map data.

Here, the pre-stored sidewalk data and average speed data may be information that is stored and maintained in a database (not shown) of the server and may be received from an external server that stores a street type, a length, a width, and a feature of each road.

Also, the server may inversely calculate a distance according to a movement of each of pedestrians into a time using the pedestrian road data. For example, the server may calculate a time according to a movement between separation distance points of a pedestrian by inversely calculating a distance according to the movement of the pedestrian into consideration of travel route measurement data based on pedestrian road data that represents a pedestrian road type and feature.

For example, with the assumption that a pedestrian road from point C to point D is a curved pedestrian road including a right-turn course and an escalator is present right before arriving at the point D by turning right, the server may exclude a duration of time or a distance used to pass the escalator into consideration of a travel distance from travel route measurement data according to a movement of the pedestrian from the point C to the point D based on the aforementioned pedestrian road data of the pedestrian road type and feature, and may inversely calculate a travel time and an average time only with respect to a movement corresponding to a general pedestrian road, that is, a pedestrian road type (e.g., the curved pedestrian road including the right-turn course) in which the pedestrian road feature (e.g., the escalator) is excluded, Therefore, the server may calculate a pure travel time or average time according to the movement between separation distance ice points excluding the pedestrian road feature.

Therefore, the server may pay a specific reward, for example, points, money, goods, a gift, a compensation, and a certificate, for a travel distance or a travel time of the pedestrian by inversely calculating the distance according to the movement of the pedestrian into time using the pedestrian road data.

Further, when an acquisition and transmission process of the pedestrian road data of the pedestrian is completed, the pedestrian road data construction method according to an example embodiment may provide information on a pedestrian road close to a location of the pedestrian in which a reward is payable based on location information of the pedestrian, for example, a pedestrian road present within a desired distance from he location of the pedestrian to the mobile device of the pedestrian, and may provide information on a reward payment method, for example, capturing of a photo, a video, etc., for the pedestrian road.

Furthermore, the pedestrian road data construction method according to an example embodiment may differentially provide a reward according to a distance, a time, and the like of a pedestrian route measured by the pedestrian, may provide a reward history paid to the pedestrian, and may provide a method capable of receiving a reward in acquiring pedestrian road data of a corresponding area. For example, when photo information or video information is insufficient for a pedestrian oad an which a pedestrian moves, the pedestrian road data construction method may recommend capturing of a photo or capturing of a video for the corresponding pedestrian road and may capture the photo or the video in a process of acquiring pedestrian route data, such that a maximum reward payable in the corresponding pedestrian road may be paid to the pedestrian.

Depending on situations, the pedestrian road data construction method according to an example embodiment may input reference information on the pedestrian road, for example, information, such as a dented hole or a slippery or an uneven road surface, through an input of the pedestrian in acquiring pedestrian road data. Here, the reference information may be transmitted to the server with the acquired pedestrian road data.

As described above, the pedestrian road data construction method according to an example embodiment may construct pedestrian map data by acquiring pedestrian road data using data collected through a mobile device of a pedestrian that moves on a pedestrian road and may provide a reward according to the acquired pedestrian road data as a compensation.

Also, the pedestrian road data construction method according to an example embodiment may acquire pedestrian road data that represents a pedestrian road feature, such as a pedestrian road type, such as a straight pedestrian road and a curved pedestrian road, and presence or absence of stairs, presence or absence of hill, presence or absence of a lift, such as an elevator or an escalator, presence or absence of an obstacle, and presence or absence of a danger area using a sensor and a camel a in a mobile device, may generate pedestrian map data constructed for each layer using the acquired pedestrian road data, and may pay a reward to a user that acquires the pedestrian road data as a compensation according to the acquired pedestrian road data.

Also, the pedestrian road data construction method according to an example embodiment may recommend pedestrian road data to be collectable from a pedestrian even in an area in which it is difficult to acquire pedestrian road data and, through this, easily acquire pedestrian road data of various areas by differentiating a reward paid as a compensation according to an area in which pedestrian road data is acquired, for example, an area in which it is easy to acquire pedestrian road data and an area in which it is difficult to acquire pedestrian road data.

Also, the pedestrian road data construction method according to an example embodiment may visually display a pedestrian road on which a pedestrian has moved on a map (or pedestrian map data) of a corresponding area in a mobile device of the pedestrian such that the pedestrian may verify pedestrian road information on the pedestrian road on which the pedestrian has moved, and may improve accuracy for a pedestrian road travel route of the pedestrian by correcting pedestrian road data displayed on the map according to a situation through a pedestrian input.

Although it is described in FIG. 1 that the pedestrian road type and feature are acquired from the mobile device, it is provided as an example only. Only travel route measurement data may be acquired from the mobile device and the server may acquire the pedestrian road type and feature through a signal processing process of the travel route measurement data.

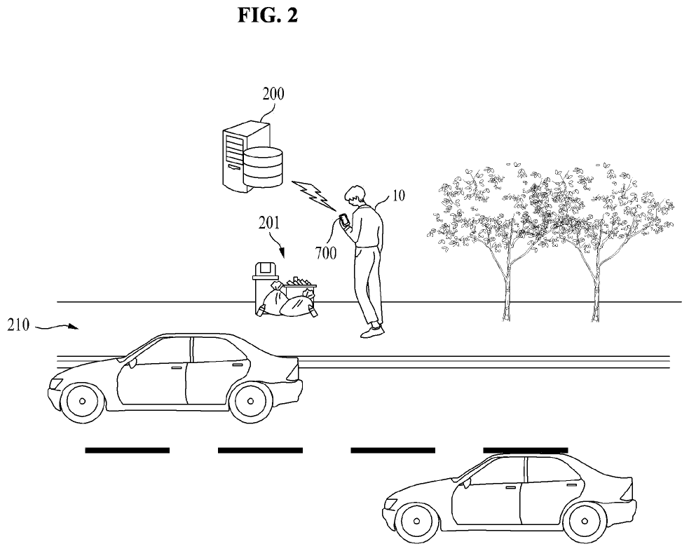

FIG. 2 illustrates an example of a process of acquiring pedestrian road data through a movement of a pedestrian according to an example embodiment.

Referring to FIG. 2, a pedestrian 10 walks on a pedestrian road 210 with a mobile device 700. Here, the pedestrian road 210 refers to a pedestrian-first road on which no vehicles pass and the present invention relates to acquiring only data related to the pedestrian road 210.

A method and system according to an example embodiment may refer to an application installed on the mobile device 700 of the pedestrian and the mobile device 700 is not limited to a smartphone and may be a wearable device worn on the wrist.

For example, when the pedestrian 10 walks on the pedestrian road 210 with the mobile device 700, the present invention acquires travel route measurement data of a travel distance and a travel time according to a location of the pedestrian 10 through a sensor in the mobile device 700 and acquires a pedestrian road image of an obstacle 201 present on the pedestrian road 210 through a camera in the mobile device 700. Therefore, the present invention may acquire the pedestrian road data that represents a pedestrian road type and feature by calculating walking speed data according to a movement between separated points of the pedestrian road 210 from the travel route measurement data and by comparing the walking speed data to pre-stored average speed data for the separated points. Here, the pre-stored average speed data may be received from a server 200.

Referring to FIG. 2, the pedestrian road 210 may be a straight road and the obstacle 201, such as tree or garbage, may be present on the pedestrian road 210. The present invention may acquire the pedestrian road data that includes the pedestrian road type, such as the straight road, and the pedestrian road feature, such as an obstacle, using the travel route measurement data and a pedestrian road image collected through the mobile device 700.

Then, the present invention may improve validity and accuracy related to pedestrian map data by comparing the pedestrian road data to pre-stored sidewalk data that is received from the server 200 and by updating the pedestrian map data. Here, the sidewalk data may refer to raw data related to the pedestrian road 210 and may include a s ee type, a length, a width, and a feature for each pedestrian road designed during road construction, and may be a base map in the pedestrian map data constructed for each layer.

The server 200 may include the sidewalk data of the street type, the length, the width, and the feature related to the pedestrian road included in the pedestrian map data, and may include average speed data for each point (or branch point) of the pedestrian road. Here, the average speed data may be a speed value that is mechanically calculated for a length of the pedestrian road included in the sidewalk data and may have a difference from walking speed data that is acquired through actual walking of the pedestrian 10.

Although it is described in FIG. 2 that the pedestrian map data is updated in the mobile device 700, it is provided as an example only. The server 300 may receive the pedestrian road data acquired by the mobile device 700, may acquire data related to each pedestrian road through analysis, and may update the pedestrian map data using the acquired pedestrian road data and then, may provide the updated pedestrian map data to the mobile device 700. Also, since data is received from a mobile device of each of a plurality of pedestrians, the present invention may easily collect pedestrian road data related to a corresponding pedestrian road, may continuously update pedestrian map data using the collected pedestrian road data, may update information on the pedestrian road that may vary over time in real time, and may provide a service using the information.

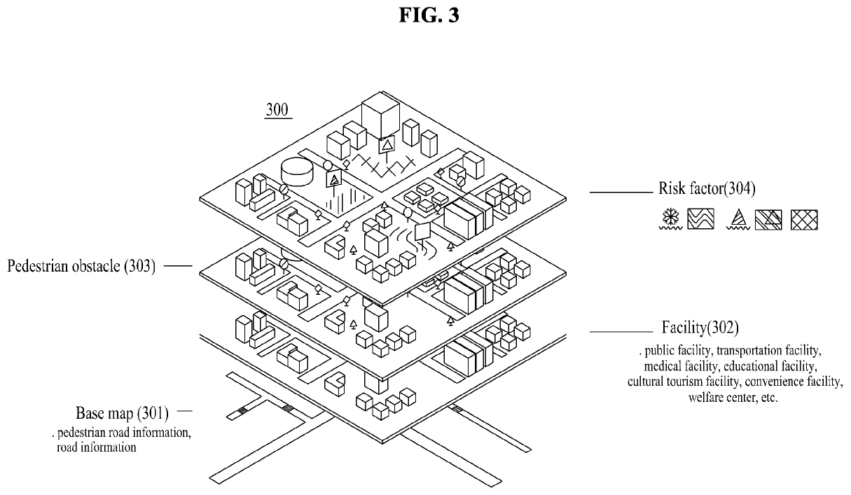

FIG. 3 illustrates an example of pedestrian map data according to an example embodiment.

Referring to FIG. 3, pedestrian map data 300 according to an example embodiment may be constructed for each layer of a base map 301, a facility map 302, a pedestrian obstacle map 303, and a risk factor map 304, and may improve management and update efficiency of data.

The base map 301 may include pedestrian road information and road information, the facility map 302 may include information on public facility, transportation facility, medical facility, educational facility, cultural tourism facility, convenience facility, and welfare center, the pedestrian obstacle map 303 may include information of a fixed obstacle and a non-fixed obstacle, and the risk factor map 304 may include risk factor information, such as icing, construction, and an accident prone area.

The base map 301 may refer to sidewalk data, and may be raw data related to a pedestrian road. For example, the base map 301 may include a street type, a length, a width, and a feature for each pedestrian road designed during road construction.

The pedestrian obstacle map 303 classifies obstacles that cause inconvenience in walking into a fixed obstacle and a changeable (non-fixed) obstacle, displays the obstacles for each phase according to a zoom level, and provides the same according to a situation. For example, a phase of the zoom level is classified into a fixed phase and a non-fixed phase and, in a street phase of the zoom level, an obstacle that causes interference in walking is classified and marked with an icon. For example, in the street phase of the zoom level, obstacles may be marked with icons, such as a traffic light, a bollard, a railing, a boundary stone, a cradle, a stop, an illegal parking, a trash can, a construction area, a manhole, and a kiosk. Also, in a building phase of the zoom level, a repetitive obstacle that is not viewed at the zoom level of the street phase, such as, for example, a street tree, a fence, and a fire hydrant, may be marked at the building phase to assist identification of the obstacle.

The risk factor map 304 may provide an icon and an area indication of icing, construction, and an accident-prone area that are hazardous to walking.

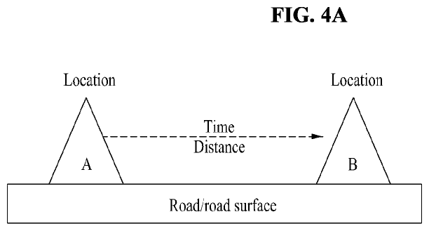

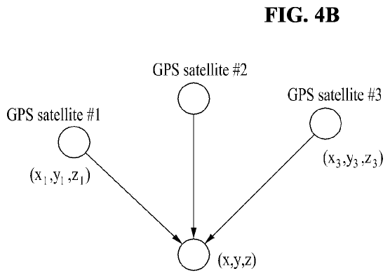

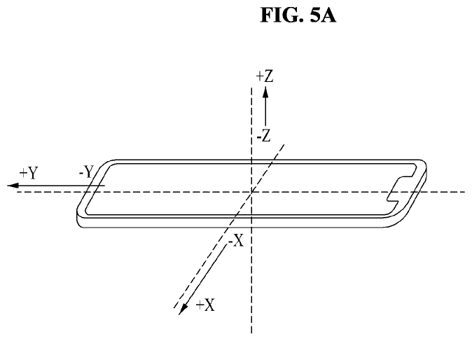

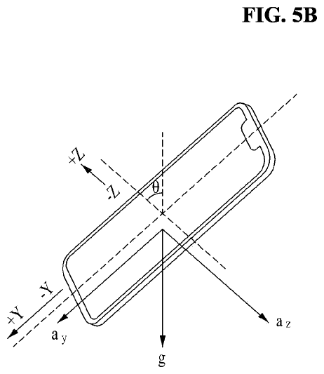

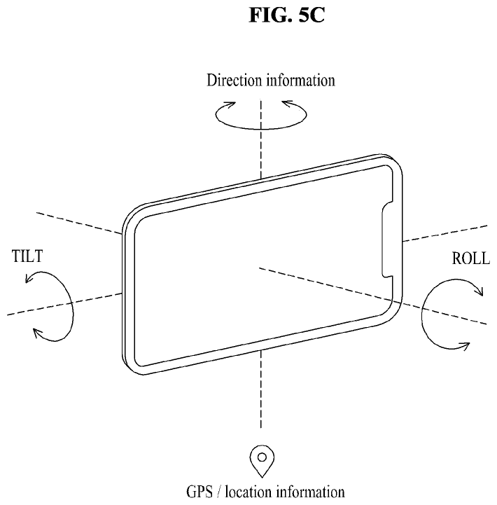

FIGS. 4A and 413 illustrate examples of a data collection through a cumulative route analysis according to an example embodiment, and FIGS. 5A to 5C illustrate examples of a data collection using a mobile device according to an example embodiment.

Referring to FIGS. 4A and 413, a time and a distance from location A to location B of a pedestrian moving on a pedestrian road and data related to a location of the pedestrian may be collected from a plurality of GPS satellites. Here, pedestrian road data according to a movement of the pedestrian may be acquired through the following Equation 1 and Equation 2.

$$F ( x ) = \frac{f ( x + h ) - f ( x )}{h} \qquad [ Equation 1 ]$$

$$\begin{matrix}{( x - {x}_{1} )}^{2} + {( y - {y}_{1} )}^{2} + {( z - {z}_{1} )}^{2} = ( {t}_{r 1} - b - {s}_{1} ) c \\ {( x - {x}_{3} )}^{2} + {( y - {y}_{3} )}^{2} + {( z - {z}_{3} )}^{2} = ( {t}_{r 3} - b - {s}_{3} ) c\end{matrix} \qquad [ Equation 2 ]$$

FIG. 5A illustrates a vertical motion of a mobile device on stairs and steps, FIG. 5B illustrates an inclination of the mobile device on a slope of a pedestrian road, and FIG. 5C illustrates an example of collecting pedestrian road data using the mobile device.

Referring to FIG. 5C, the present invention may acquire pedestrian road data using a travel speed (acceleration) measurement algorithm (Equation 3)), an inclination (angle) measurement algorithm (Equation 4), and a pedestrian road type (angular velocity) measurement algorithm (Equation 5) based on location information, direction information, and inclination information of a pedestrian acquired from a GPS sensor, a magnetic sensor, an acceleration sensor, a gyro sensor, and a gravity sensor

$$\begin{matrix}{a}_{y} ( k ) = g sin ( θ ( k ) ) \\ {a}_{z} ( k ) = g cos ( θ ( k ) )\end{matrix} \qquad [ Equation 3 ]$$

$$θ = {tan}^{- 1} ( \frac{{a}_{y}}{{a}_{z}} ) = {tan}^{- 1} ( \frac{g sin ( θ ( k ) )}{g cos ( θ ( k ) )} ) \qquad [ Equation 4 ]$$

$$θ = {\int }_{0}^{{t}_{f}} ω ( t ) dt \qquad [ Equation 5 ]$$

Here, since Equation 1 to Equation 5 are widely used in the art, further description is omitted.

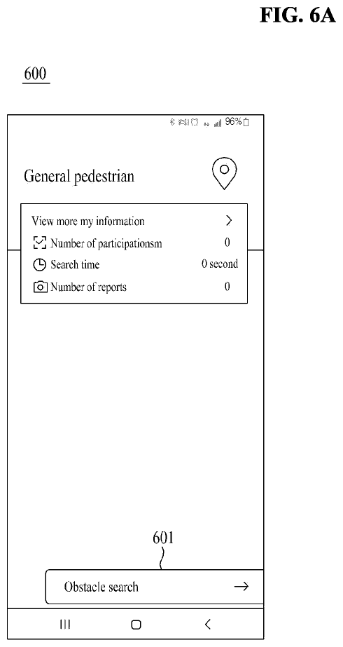

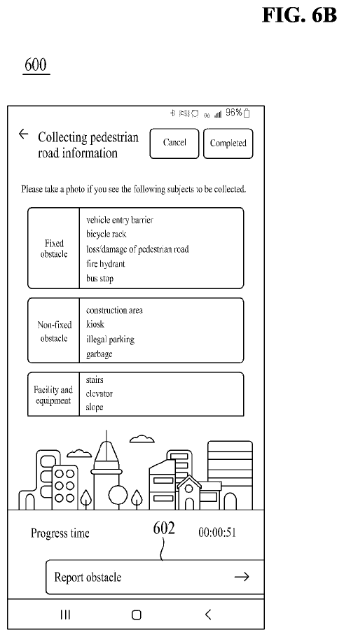

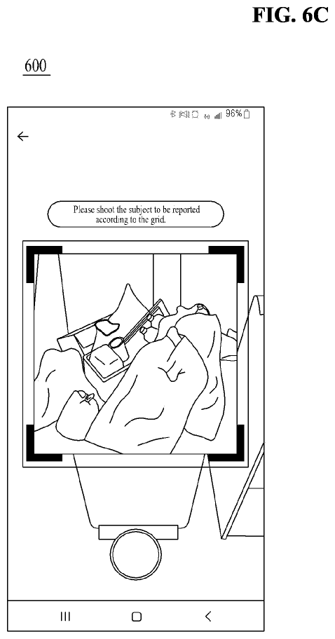

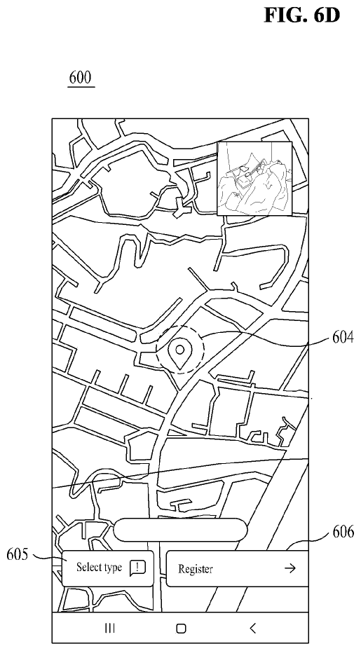

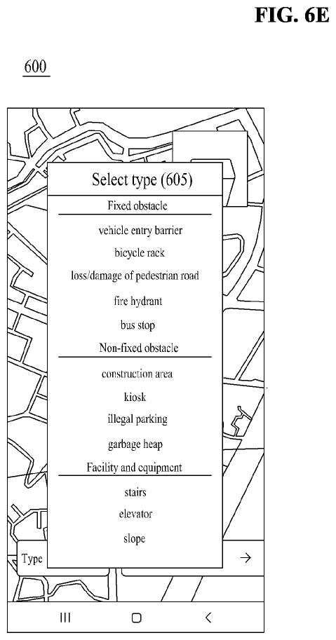

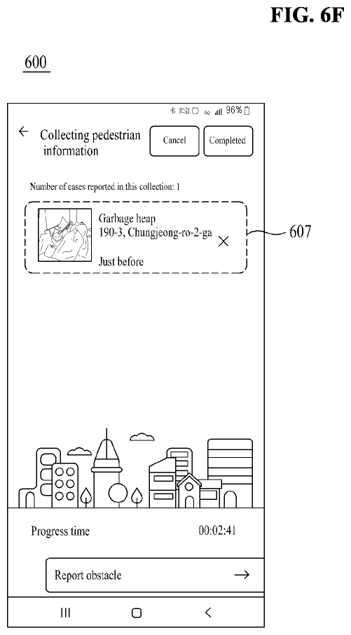

FIGS. 6A to 6F illustrate examples of an application user interface (UI) according to an example embodiment.

FIGS. 6A to 6F relate to an application UI according to an example embodiment executed on a mobile device of a pedestrian and are to explain an execution operation according to a selection input of the pedestrian.

Referring to FIG. 6A, when a pedestrian finds a garbage on a road while moving on a pedestrian road, the pedestrian may select an obstacle search 601 using an application executed on a mobile device 600. The pedestrian may report (602) a fixed obstacle, a non-fixed obstacle, or an obstacle of facility/equipment (FIG. 6B).

Referring to FIGS. 6C, 6D, and 6E, the pedestrian may take a photo of the garbage on the road using a camera of the mobile device 600, may verify a current location 604 of the pedestrian and then may select (605) a type of an obstacle. Here, a type selection (605) provides a list of fixed obstacles, such as a vehicle entry barrier, a bicycle rack, loss/damage of a pedestrian road, a fire hydrant, and a bus stop, or non-fixed obstacles, such as a construction area, a kiosk, an illegal parking, and a garbage heap, and facility/equipment obstacles, such as stairs, an elevator, and a slope.

When the pedestrian selects (605) the type of the obstacle, the garbage present on the road and then selects a register 606 in FIG. 6D, a report reception is completed (607) as in FIG. 6F.

Therefore, the present invention may update pedestrian map data in real time based on pedestrian road data reported by the pedestrian.

FIG. 7 is a block diagram illustrating a configuration of a pedestrian road data construction system according to an example embodiment.

Referring to FIG. 7, a pedestrian road data construction system 700 according to an example embodiment includes an acquirer 710, a manager 720, and a compensator 730, and represents a conceptual configuration of a mobile device of FIG. 2.

The acquirer 710 acquires pedestrian road data related to a pedestrian route of a pedestrian using sensors provided in a mobile device of the pedestrian.

In detail, the acquirer 710 may include a data acquirer configured to acquire travel route measurement data of a travel distance and a travel time according to the pedestrian route using a sensor, for example, a GPS sensor, a magnetic sensor, an acceleration sensor, a gyro sensor, and a gravity sensor, in the mobile device and to acquire a pedestrian road image of the pedestrian route using a camera in the mobile device, and a data processing configured to calculate walking speed data according to a movement of the pedestrian from the pedestrian road image and the travel route measurement data and to process the pedestrian road data that represents a pedestrian road type and feature.

Here, the acquirer 710 may acquire data related to a pedestrian road on which the pedestrian has moved through the GPS sensor, the magnetic sensor, the acceleration sensor, the gyro sensor, and the gravity sensor provided in the mobile device and a measurement device of the camera in such a manner that an application according to a system of the present invention installed on the mobile device is executed based on an input of the pedestrian.

The pedestrian road data acquired by the data acquirer may include location information, direction information, acceleration information, gyro information, and the like, and may acquire travel route measurement data of a travel distance and a travel time according to a location of the pedestrian by sensing the location of the pedestrian that moves on the pedestrian road in real time based on such information. For example, the data acquirer may sense a location of the pedestrian that moves on the pedestrian road using at least one sensor among the GPS sensor, the magnetic sensor, the acceleration sensor, the gyro sensor, and the gravity sensor provided in the mobile device, and may acquire the travel route measurement data that represents a travel distance and a travel time according to a movement through a change in a walking speed, direction, and altitude of the pedestrian. Here, the travel route measurement data refers to data acquired from a sensor in the mobile device and may further include information related to a travel direction, a duration of time stayed at a single point, and a detour for avoiding an obstacle or a structure as well as the travel distance and the travel time according to the movement of the pedestrian.

The data acquirer may acquire a pedestrian road image captured from the pedestrian road in the pedestrian route using the camera in the mobile device while the pedestrian is moving. For example, the pedestrian with the mobile device may take a photo of an interfering object in the pedestrian road, such as an obstacle present in the pedestrian road, icing, piled snow, or leaves, through the camera, while moving on the pedestrian road. The data acquirer may acquire the pedestrian road image of the obstacle.

Further, the data acquirer may acquire travel route measurement data including inclination information, a camera direction, and a camera capturing location of the mobile device according to the movement of the pedestrian. As an example embodiment, the data acquirer may acquire the travel route measurement data including presence or absence of a slope or hill on the road according to the inclination information of the mobile device, the camera direction and the camera capturing location of the mobile device, an angle of inclination, and the pedestrian road image using the gyro sensor and the camera included in the mobile device.

For example, the pedestrian may walk after putting the mobile device into a bag or clothes, may walk while holding the mobile device with the hand, may walk while viewing the mobile device, or may walk while taking a photo with the camera of the mobile device ON. Therefore, the data acquirer may sense presence or absence of a slope or hill on the pedestrian road and may verity an angle of inclination of the slope or the hill by acquiring the travel distance and the travel time according to the movement of the pedestrian and by acquiring inclination information and a camera direction of the mobile device through at least one sensor=anon; the GPS sensor, the magnetic sensor, the acceleration sensor, the gyro sensor, and the gravity sensor, and the camera. Also, when the pedestrian walks while taking a photo with the camera of the mobile device ON, the data acquirer may acquire the pedestrian road image.

Therefore, the data acquirer may measure more detailed information on the pedestrian road by acquiring travel route measurement data that includes a travel direction, a duration of time stayed at a single point, a detour for avoiding an obstacle or a structure, presence or absence of a slope or hill on the road, an angle of inclination, and a pedestrian road image as well as the travel distance and the travel time based on sensing data that is measured through a measurement device provided in the mobile device.

The data processing may acquire the pedestrian road type and feature by calculating walking speed data according to the movement of the pedestrian from the travel route measurement data and by comparing the walking speed data to average speed data according to a movement between pre-stored separation distance points.

Further, when it is determined that the pedestrian has moved by way of a transportation method other than walking in acquiring pedestrian road data according to the travel route of the pedestrian, for example, when a travel speed of the pedestrian exceeds a desired reference speed, the data processing may determine that the pedestrian has moved by way of the transportation method and may delete corresponding pedestrian road data from pedestrian road data of the pedestrian.

In detail, the data processing may acquire the pedestrian road data representing the pedestrian road type and feature by calculating the walking speed data according to the movement of the pedestrian from the travel route measurement data. Here, the data processing may acquire the pedestrian road type and feature by calculating an average speed, that is, the walking speed data according to the movement of the pedestrian from the travel route measurement data and by comparing the calculated walking speed data to the pre-stored average speed data according to the movement between the separation distance points. For example, when the pedestrian moves from point A to point B of a pedestrian road, the data processing may calculate walking speed data of an average speed according to a travel distance and a travel time from the travel route measurement data acquired according to the movement of the pedestrian. Therefore, the data processing may acquire at least one pedestrian road feature among a pedestrian road type, such as a straight pedestrian road and a curved pedestrian road, and presence or absence of stairs, presence or absence of hill, presence or absence of a lift, such as an elevator or an escalator, presence or absence of an obstacle, and presence or absence of a danger area by comparing the walking speed data to the average speed data that is mechanically calculated from a distance from the point A to the point B, received from a database (not shown) or an external server. Here, when a history related to a walking speed of the pedestrian is present, the data processing may, acquire at least one pedestrian road feature among the pedestrian road type, such as the straight pedestrian road and the curved pedestrian road, and presence or absence of stairs, presence or absence of hill, presence or absence of a lift, such as an elevator or an escalator, presence or absence of an obstacle, and presence or absence of a danger area through comparison between the walking speed of the pedestrian and the walking speed acquired from the travel route measurement data.

Therefore, the data processing may verify the pedestrian road type and feature by comparing the walking; speed data to previous average speed data acquired for the corresponding pedestrian route and may acquire the pedestrian road data related to the corresponding pedestrian route through which only the pedestrian moves.

The manager 720 constructs pedestrian map data related to the pedestrian route for each layer using the pedestrian road data.

The manager 720 may generate pedestrian map data constructed for each layer of a base map, a facility map, a pedestrian obstacle map, and a risk factor map using the pedestrian road data, and may distinguish an obstacle as a fixed obstacle or a non-fixed obstacle and generate the same into data in a pedestrian obstacle map. For example, the manager 720 may construct the pedestrian map data by generating the facility map, such as public facility, transportation facility, medical facility, educational facility, cultural tourism facility, convenience facility, and welfare center, on the base map that shows pedestrian road information and road information, by generating the pedestrian obstacle map of a fixed obstacle and a non-fixed obstacle on the facility map, and by generating the risk factor map, such as icing, construction, and an accident prone area, on a top layer.

Here, the manager 720 may update data related to a pedestrian obstacle through an analysis and verification process of processing and refining the pedestrian road data collected from the pedestrian and recognizing a location and a range of an obstacle and generating new obstacle data based on an AI model learning. Also, the manager 720 may classify a pedestrian road image of a risk factor, such as icing, collected from the pedestrian, through an AI model classification and may update obstacle data using a photo through an interface through classification data grouping and a GTS data analysis.

Also, since the manager 720 displays the pedestrian road data on the pedestrian map data displayed on a screen of the mobile device, the pedestrian may visually verify the pedestrian route through which the pedestrian has moved in real time.

Here, when displaying the pedestrian road data on a map, the manager 720 may differently display the pedestrian road data according to a travel speed at which the pedestrian moves, a slope of a road, and the like. When the pedestrian route through which the pedestrian has moved is pre-stored, the manager 720 may update pedestrian map data related to an overlapping route using the pre-stored pedestrian road data of the corresponding route and newly measured pedestrian road data or may update the same with an average value.

Further, the manager 720 may correct the pedestrian road data that is displayed in real time on the screen or of which measurement is terminated and that is displayed on the screen based on an input of the pedestrian. For example, when the pedestrian road data displayed on the screen has a portion different from the pedestrian route of the pedestrian, the manager 720 may correct the pedestrian road data by correcting the pedestrian road data related to the different portion based on an input of the pedestrian. Here, a function of correcting may be performed by a control method provided to a display and may be performed by a control method that controls the system.

That is, the system according to the present invention in ay improve accuracy of the pedestrian road data acquired according to the pedestrian route of the pedestrian by determining an area to be corrected according to the input of the pedestrian in the pedestrian road data that is acquired based on sensing data measured by sensors and by correcting data of the area to be corrected based on input information of the pedestrian. Here, the accuracy of the pedestrian road data may be improved through a signal processing process at a server and complexity of signal processing at the server may be reduced through the aforementioned correction operation of the pedestrian.

When acquisition of the pedestrian road data is completed, the compensator 730 pays a reward differentiated according to location information of the pedestrian road data and a distance of the pedestrian route.

When acquisition of the pedestrian road data is completed, the compensator 730 may provide information on a pedestrian road within a desired distance in which a reward is payable based on location information of the pedestrian and a reward payment method on the corresponding pedestrian road to the pedestrian. Here, the compensator 730 may differentiate reward to be paid according to a location at which the pedestrian road data is acquired or the pedestrian route and, as an example embodiment, may provide the differentiated reward by applying a weight differentiated by area to a reference reward.

For example, the compensator 730 may differentiate the reward to be paid to the pedestrian according to a case in which an acquisition location of the pedestrian road data is a pedestrian road in which a data acquisition is easy and a case in which the acquisition location is a pedestrian road in which a data acquisition is difficult, for example, a case in which it is a pedestrian road in acquisition of the pedestrian road data is insufficient based on location information at which the pedestrian road data is acquired.

Also, the pedestrian road data construction system 700 according to an example embodiment may further include a calculator configured to inversely calculate a distance according to the movement of the pedestrian into a time using the pedestrian road data. In detail, the calculator may calculate a time according a movement between separation distance points of the pedestrian by inversely calculating the distance according to the movement of the pedestrian into the time into consideration of the travel route measurement data, based on the pedestrian road data that represents the pedestrian road type and feature.

For example, with the assumption that a pedestrian road from point C to point D is a curved pedestrian road including a right-turn course and an escalator is present right before arriving at the point D by turning right, the calculator may exclude a duration of time or a distance used to pass the escalator into consideration of a travel distance from travel route measurement data according to a movement of the pedestrian from the point C to the point D based on the aforementioned pedestrian road data of the pedestrian road type and feature, and may inversely calculate a travel time and an average time only with respect to a movement corresponding to a general pedestrian road, that is, a pedestrian road type (e.g., the curved pedestrian road including the right-turn course) in which the pedestrian road feature (e.g., the escalator) is excluded. Therefore, the calculator may calculate a pure travel time or average time according to the movement between separation distance points excluding the pedestrian road feature.

The pedestrian road data construction system 700 according to an example embodiment may further include a transmitter configured to transmit the pedestrian road data to a preset server when acquisition of the pedestrian road data is completed. After acquisition of the pedestrian road data is completed, the manager 720 may correct the pedestrian road data displayed on the pedestrian map data based on an input of the pedestrian and may transmit the corrected pedestrian road data to the server. Depending on example embodiments, the present invention may transmit the pedestrian road data to the server and receive pedestrian map data and the reward constructed by the server and may pay the pedestrian map data and the reward to the pedestrian using the mobile device through the manager 720 and the compensator 730.

The server that receives the pedestrian road data through the transmitter may acquire accurate information on each of pedestrian roads by collecting pedestrian road data from each of pedestrians and extracting data related to each of the pedestrian roads based on the collected pedestrian road data and then, analyzing the extracted data related to each of the pedestrian roads. For example, when pedestrian road data is received from pedestrian A, pedestrian B, and pedestrian C for the same pedestrian road, the server may acquire accurate pedestrian road data related to the corresponding pedestrian road by averaging the pedestrian road data of the pedestrian A, the pedestrian road data of the pedestrian B, and the pedestrian road data of the pedestrian C and by comparing sidewalk data or pedestrian road data pre-stored for the corresponding pedestrian road to the averaged pedestrian road data. Here, for the corresponding pedestrian road, significantly different pedestrian road data may be excluded in analyzing the pedestrian road data. When pedestrian road data is updated for the corresponding pedestrian road, pedestrian road data stored for the corresponding pedestrian road may be updated with new data.

Also, the server may appropriately map pedestrian road data collected from a plurality of pedestrians to the pre-stored sidewalk data or pedestrian map data and may provide the same.

The server that receives the pedestrian road data from the pedestrians may improve validity and accuracy of the sidewalk data by analyzing the pedestrian road data and then combining the same with sidewalk data pre-stored for a corresponding area. Here, the pre-stored sidewalk data and average speed data may be information that is stored and maintained in a database (not shown) of the server and may be received from an external server that stores a street type, a length, a width, and a feature of each road.

Although the description is omitted in the system of FIG. 7, it is apparent to those skilled in the art that each component that constitutes FIG. 7 mays include all the contents described with reference to FIGS. 1 to 6F.

The systems or apparatuses described herein may be implemented using hardware components, software components, and a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The media may include, in combination with program instructions, data files, data structures, and the like. The program instructions recorded in the media may be specially designed and configured for the example embodiments or may be known to those in the computer software and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like.

Examples of the program instruction may include a machine code as produced by a compiler and include a high-language code executable by a computer using an interpreter and the like. The hardware device may be configured to operate as at least one software module or vice versa.

### Mode

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and replaced or supplemented by other components or their equivalents.

Therefore, other implementations, other example embodiments, and equivalents of the claims are to be construed as being included in the claims.

What is claimed is:

1. A method of constructing pedestrian road data, the method comprising:
acquiring pedestrian road data related to a pedestrian route of a pedestrian using sensors provided in a mobile device of the pedestrian;
constructing pedestrian map data related to the pedestrian route for each layer using the pedestrian road data; and
paying a reward differentiated according to location information of the pedestrian road data and a distance of the pedestrian route when acquisition of the pedestrian road data is completed.

2. The method of claim 1, wherein the acquiring of the pedestrian road data comprises:
acquiring travel route measurement data of a travel distance and a travel time according to the pedestrian route using a sensor in the mobile device and acquiring a pedestrian road image of the pedestrian route using a camera in the mobile device; and
calculating walking speed data according to a movement of the pedestrian from the pedestrian road image and the travel route measurement data and processing the pedestrian road data that represents a pedestrian road type and feature.

3. The method of claim 1, wherein the acquiring of the travel route measurement data and the pedestrian road data comprises sensing a location of the pedestrian that moves on a pedestrian road using a global positioning system (GPS) sensor and an acceleration sensor in the mobile device and acquiring the travel route measurement data that represents a travel distance and a travel time according to a movement through a change in a walking speed, direction, and altitude of the pedestrian, and acquiring the pedestrian road image captured by the pedestrian from the pedestrian road in the pedestrian route using a camera in the mobile device.

4. The method of claim 3, wherein the processing of the travel route measurement data comprises acquiring the pedestrian road type and feature by calculating the walking speed data according to the movement of the pedestrian from the travel route measurement data and by comparing the walking speed data to average speed data according to a movement between pre-stored separation distance points.

5. The method of claim 4, wherein the processing of the travel route measurement data comprises acquiring the pedestrian road data related to a pedestrian road on which only the pedestrian moves by acquiring at least one pedestrian road feature among a pedestrian road type of a straight pedestrian road and a curved pedestrian road, presence or absence of stairs, presence or absence of hill, presence or absence of a lift of an elevator or an escalator, presence or absence of an obstacle, and presence or absence of a danger area based on a comparison result and the pedestrian road image.

6. The method of claim 1, wherein the constructing of the pedestrian map data for each layer comprises generating the pedestrian map data constructed for each layer of a base map, a facility map, a pedestrian obstacle map, and a risk factor map using the pedestrian road data.

7. The method of claim 6, wherein the constructing of the pedestrian map data for each layer comprises distinguishing an obstacle as a fixed obstacle or a non-fixed obstacle and generating the obstacle into data in the pedestrian obstacle map.

8. The method of claim 1, wherein the paying of the reward comprises providing information on a pedestrian road within a desired distance in which a reward is payable based on location information of the pedestrian and a reward payment method on the corresponding pedestrian road to the pedestrian, when acquisition of the pedestrian road data is completed.

9. The method of claim 1, further comprising:
transmitting the pedestrian road data to a preset server when acquisition of the pedestrian road data is completed.

10. The method of claim 9, further comprising:
correcting the pedestrian road data indicated in the pedestrian map data based on an input of the pedestrian when acquisition of the pedestrian road data is completed,
wherein the transmitting comprises transmitting the corrected pedestrian road data to the server.

11. The method of claim 1, further comprising:
inversely calculating a distance according to a movement of the pedestrian the pedestrian road data.

12. A pedestrian road data construction system comprising:
an acquirer configured to acquire pedestrian road data related to a pedestrian route of a pedestrian using sensors provided in a mobile device of the pedestrian;
a manager configured to construct pedestrian map data related to the pedestrian rotate for each layer using the pedestrian road data; and
a compensator configured to pay a reward differentiated according to location information of the pedestrian road data and a distance of the pedestrian route when acquisition of the pedestrian road data is completed.

13. The pedestrian road data construction system of claim 12, wherein the acquirer comprises:
a data acquirer configured to acquire travel route measurement data of a travel distance and a travel time according to the pedestrian route using a sensor in the mobile device and to acquire a pedestrian road image of the pedestrian route using a camera in the mobile device; and
a data processing configured to calculate walking speed data according to a movement of the pedestrian from the pedestrian road image and the travel route measurement data and to process the pedestrian road data that represents a pedestrian road type and feature.

14. The pedestrian road data construction system of claim 12, further comprising:
a transmitter configured to transmit the pedestrian road data to a preset server when acquisition of the pedestrian road data is completed.

15. The pedestrian road data construction system of claim 14, wherein the manager is configured to correct the pedestrian road data indicated in the pedestrian map data based on an input of the pedestrian when acquisition of the pedestrian road data is completed, and
the transmitter is configured to transmit the corrected pedestrian road data to the server.

16. The pedestrian road data construction system of claim 12, wherein the manager is configured to generate the pedestrian map data constructed for each layer of a base map, a facility map, a pedestrian obstacle map, and a risk factor map using the pedestrian road data.

17. The pedestrian road data construction system of claim 16, wherein the manager is configured to distinguish an obstacle as a fixed obstacle or a non-fixed obstacle and to generate the obstacle into data in the pedestrian obstacle map.

18. The pedestrian road data construction system of claim 12, wherein the compensator is configured to provide information on a pedestrian road within a desired distance in which a reward is payable based on location information of the pedestrian and a reward payment method on the corresponding pedestrian road to the pedestrian, when acquisition of the pedestrian road data is completed.

19. The pedestrian road data construction system of claim 12, further comprising:
a calculator configured to inversely calculate a distance according to a movement of the pedestrian using the pedestrian road data.
